(19) United States
(12) Patent Application Publication
(10) Pub. No.: US 2022/0205112 A1
(43) Pub. Date: Jun. 30, 2022

(54) CORROSION CONTROL OF STAINLESS STEELS IN WATER SYSTEMS USING TIN CORROSION INHIBITOR WITH A HYDROXYCARBOXYLIC ACID

(71) Applicant: CHEMTREAT, INC., Glen Allen, VA (US)

(72) Inventors: Prasad KALAKODIMI, Glen Allen, VA (US); Santanu BANERJEE, Glen Allen, VA (US); Curt TURNER, Mechanicsville, VA (US)

(73) Assignee: CHEMTREAT, INC., Glen Allen, VA (US)

(21) Appl. No.: 17/138,073

(22) Filed: Dec. 30, 2020

(51) Int. Cl. C23F 11/04; C09K 15/02; C09K 15/06

(52) U.S. Cl. CPC C23F 11/04; C09K 15/06; C09K 15/02

(57) ABSTRACT

Methods for suppressing corrosion of a corrodible stainless steel surface that contacts a water stream in a water system. The method comprises introducing into the water stream a treatment composition, the treatment composition including a Tin(II) corrosion inhibitor and a hydroxycarboxylic acid promoter.

### TECHNICAL FIELD

This application is directed to methods and compositions for corrosion inhibitor treatment of stainless steels in water systems, such as those used in industrial processes.

### BACKGROUND

Corrosion of stainless steels in industrial water systems is a serious problem. It causes undesirable consequences, including loss of heat transfer, increased cleaning frequency, equipment repairs and replacements, shutdowns, environmental problems and the increasing resources and costs associated with each. Austenitic stainless steels such as Type 304 (UNS 30400) and Type 316 (UNS 31600) are commonly used as the metallurgy of choice for heat exchangers in cooling waters. These steels are characterized as having excellent corrosion resistance and good mechanical and physical properties for long service life. However, austenitic stainless steels are subject to pitting and crevice corrosion in warm chloride environments and to stress corrosion cracking above about 140° F. metal skin temperature.

Other mechanisms such as deposition, microbial activity, and low flow have also been known to promote pitting corrosion. In many industries, cooling water cycles of concentration are often limited by the chloride levels in order to reduce pitting and stress cracking tendencies, which increases the water consumption and operating cost for the plant. This also does not allow the plants to use alternate water sources such as reclaimed or reuse waters, as those waters generally come with higher amount of chlorides.

The presence of chromium is mainly responsible for the resistance of stainless steels to corrosion. The presence of chromium promotes a protective oxide film on stainless steels, which is also called passive layer. Passivity, the mechanism by which the stainless steels derive their corrosion resistance, has been the subject of electrochemical research for many years. The passive film provides a protective barrier between the stainless steel surface and the surrounding environment. Some aggressive ions such as chlorides and sulfates are capable of causing localized breakdown of the passive film. When the breakdown of the passivation occurs under the conditions where repassivation is not possible, pitting attack can occur on stainless steels. The austenitic stainless steels may also be subjected to stress corrosion cracking in chloride environments at high temperatures (e.g., above 130 to 140° F.), if tensile stresses are present.

Austenitic stainless steels are extensively used as heat exchangers (shell & tube and plate & frame) in petroleum refining and chemical plant applications due to corrosion resistance against sulfur compounds and various acid contaminants which may be present in the refining process of the crude oil. Other applications of stainless steels are condensers, reactors, and piping. In many refineries and petrochemical applications, the material selection is governed by the cooling water and the chloride content in the cooling water, which can lead to pitting and stress corrosion cracking.

Pitting is a form of localized corrosion which is known to initiate due to the breakdown of the passive film. The most common cause of stainless steel pitting is contact with water containing high chlorides. It is very common for refineries and petrochemicals/chemical plants to maintain high residual chlorine in their cooling towers. Hypochlorite ions in bleach solutions are a highly aggressive pitting corrosion agent. Localized corrosion in the form of pit and crevices in corrosion resistant alloys is one of the biggest challenges for material selection for applications in the oil and gas industry. Pitting resistance equivalent number (PREN) is often used to predict pitting behavior and select the appropriate grade of stainless steel.

Methods for improved and effective use of Tin-based corrosion inhibitors by including a hydroxycarboxylic acid promoter compound that enhances the effectiveness of the Tin-based corrosion inhibitor while allowing much smaller concentrations of inhibitor and promoter are known. Examples of such methods may be found in, for example, U.S. Pat. No. 10,174,429 to Kalakodimi et al. (“Kalakodimi”), which is hereby incorporated by reference herein in its entirety. Hydroxycarboxylic acids (carboxylic acid substituted with a hydroxyl group on the adjacent carbon) are known organic compounds which are studied for various applications. See Kalakodimi. Examples of these compounds are tartaric acids, Glucaric acid, maleic aicd, gluconic acid, and polyaspartic acid.

Prior to Kalakodimi, treatment of corrosion in water systems was typically achieved by continuous application of various corrosion inhibitors in the water including, for example, phosphates, polymer, chromates, zinc, molybdates, nitrites, and combinations thereof. These inhibitors work by the principle of shifting the electrochemical corrosion potential of the corroding metal in the positive direction indicating the retardation of the anodic process (anodic control), or displacement in the negative direction indicating mainly retardation of the cathodic process (cathodic control). Previous corrosion inhibition programs utilized the stannous salts in much the same manner as conventional corrosion inhibitors in which doses of the stannous inhibitors were introduced into the aqueous systems to maintain a minimum stannous concentration in order to be effective. Conventional corrosion inhibition practices with Tin compounds have not been able to effectively deal with the problem of maintaining an effective amount of Tin(II) in solution long enough to form a protective film on the surface of the corrosive metal without losing the active form, Tin (II), perhaps due to bulk phase oxidation and precipitation to Tin (IV).

However, none of the traditional corrosion inhibition methods, which used inorganic phosphates, organic phosphates, zinc, molybdate, and nitrite, provided any significant inhibition towards pitting and stress corrosion cracking of stainless steels. Use of organic compounds as corrosion inhibitors has been challenging and, in many cases, prohibitive due to volume and cost requirements in the context of stainless steels. Consequently, the cycles of concentration (COC) are often limited in cooling towers to avoid exceeding the acceptable chloride limit for the alloy.

These and other issues are addressed by the present disclosure.

### SUMMARY

The inventors conducted extensive research into the effects of the combination of stannous and hydroxycarboxylic acids, the so-called Reactive Polyhydroxy Starch Inhibitor (RPSI). Upon extensive evaluation of the performance of the RPSI chemistry in inhibiting pitting and stress corrosion cracking of stainless steels, it was found that a synergistic combination of small amounts of stannous salts with hydroxylcarboxylic acids provide unexpectedly beneficial effects in inhibiting pitting and stress corrosion cracking in stainless steels.

It is an object of this disclosure to provide methods for improved and effective use of Tin-based corrosion inhibitors by including a promoter compound that enhances the effectiveness of the Tin-based corrosion inhibitor while allowing much smaller concentrations of inhibitor and promoter than previously known or contemplated in the treatment of stainless steels. Without intending to be bound by theory, it is believed that the promoter compound is accomplishing two processes: (1) it is forming a corrosion inhibiting film on the metal surface, and (2) it is effectively chelating Tin(II) in solution long enough to form a protective film on the surface of the corrosive metal without losing active form. This film of Tin (IV) is shown to have remarkably better corrosion rates than either Ti(II) or the promoter alone and in lower concentrations than expected.

In a first embodiment, there is provided a method of suppressing corrosion of a corrodible stainless steel surface that contacts a water stream in a water system. The method includes introducing into the water stream that contacts the corrodible stainless steel surface a treatment composition including a Tin(II) corrosion inhibitor and a hydroxycarboxylic acid promoter, wherein the treatment composition is introduced so that a concentration of the treatment composition in the water stream is in the range of 0.1 ppm to 1000 ppm.

### BRIEF DESCRIPTION OF THE DRAWINGS

FIG. 1 is a schematic view of an electrochemical setup used in evaluating the examples of the disclosed embodiments.

FIG. 2 is a graph showing a cyclic polarization curve used in evaluating the examples of the disclosed embodiments.

FIG. 3 is a graph illustration of the critical corrosion parameters for the Samples shown in Table 1.

FIGS. 4A, 4B and 4C are pictures of Samples in Table 1.

FIG. 5 is a graph illustration of the critical corrosion parameters for the Samples shown in Table 2.

FIGS. 6A and 6B are pictures comparing the benefits of the disclosed embodiments in terms of pitting.

FIGS. 7A and 7B are pictures comparing the benefits of the disclosed embodiments in terms of crevice corrosion.

FIGS. 8A and 8B are pictures comparing the benefits of the disclosed embodiments in terms of stress corrosion cracking.

### DETAILED DESCRIPTION

### Overview

Embodiments of the disclosed methods and compositions apply the discovery of improved corrosion inhibition of stainless steels in water systems including, but not limited to cooling towers, water distribution systems, boilers, pasteurizers, water and brine carrying pipelines, storage tanks and the like. Embodiments of the methods and compositions are particularly useful with cooling towers in industrial water processes. Improved corrosion inhibition can be achieved at lower cost and with less environmental impact by treating stainless steels in water systems with a corrosion inhibitor and a promoter compound. Disclosed embodiments form a very tenacious and persistent inhibitor film on the surface of corrodible stainless steels by treatment with a corrosion inhibitor together with a promoter compound. As explained below, the methods of treating water systems with a corrosion inhibitor and a promoter compound are particularly useful for stannous corrosion inhibitors and hydroxycarboxylic acids.

These treatment methods result in synergistic corrosion inhibition and a significant reduction in the amount of corrosion inhibitor and promoter required, which is beneficial for the environment and reduces the cost of treatment. The methods provide for more economical treatment of large volume systems including, for example, once-through applications and other systems in which the water consumption and losses pose a significant challenge for dosage and control using conventional anti-corrosion treatments. The methods also greatly reduce the amount of corrosion inhibitor(s), such as stannous salts, required to protect the treated system by reducing consumptive losses associated with oxidation and discharge of water from the system.

Embodiments using stannous inhibitors are also beneficial if the effluent from the treated system is being used in a manner or for a purpose where a conventional inhibitor would be regarded as a contaminant or otherwise detrimental to the intended use. Such stannous-based corrosion inhibitors are more tolerant of overdosing when compared to conventional zinc or phosphate programs which rely on high volumes of polymeric dispersants to suppress formation of unwanted deposits.

Stannous corrosion inhibitors particularly suitable for use with the disclosed methods include Tin(II) compounds. Tin(II) is more soluble in aqueous solutions than a higher oxidation state metal ion, such as Tin(IV). For such metals, the lower oxidation state species can be introduced into the treated system by, for example, introducing a stannous salt directly or by feeding a concentrated solution into the treated system. Corrosion inhibitors are consumed within a treated system in various ways. These consumption pathways can be categorized as system demand and surface demand. Together, system demand and surface demand comprise total inhibitor demand.

System demand, in many scenarios, is attributed to the presence of oxygen, halogens, other oxidizing species and other components in the aqueous system that can react with or remove, and thereby deactivate or consume, the inhibitor. With stannous salt treatments, for example, oxidizing species can convert the preferred Tin(II) stannous ions to largely ineffective (at least in the process water stream) Tin(IV) stannate ions. System demand also includes inhibitor losses associated with bulk water loss through, for example, blow down and/or other discharges from the treated system.

Surface demand is the consumption of the inhibitor attributed to the interaction between the inhibitor and a reactive metal surface. Surface demand will decline as the inhibitor forms a protective film or layer on those metal surfaces that were vulnerable to corrosion. Once all of the wetted surfaces have been adequately protected, the surface demand may be nothing or almost nothing. Once the surface demand is reduced to values close to zero, the requirement for additional corrosion inhibitor may be substantially reduced or even terminated for some period of time without compromising the effectiveness of the corrosion inhibition.

Stannous compounds undergo oxidation at the vulnerable surfaces of the stainless steel, or those surfaces in need of corrosion protection, and form an insoluble protective film. These surfaces can also react with the stannous compounds to form metal-tin complexes, which again form protective films on the stainless steel surface. Without intending to be bound by theory, stannous inhibitors applied in accordance with the disclosed methods appear to form a protective film on the stainless steel by at least three mechanisms. A first mechanism involves forming an insoluble stannous hydroxide layer under alkaline conditions. This stannous hydroxide appears to oxidize further to form a stannate oxide layer, which is even more insoluble, resulting in a protective film which is resistant to dissolution from the surface even in the absence of stannous salts in the process water. A second mechanism may be achieved under acidic conditions or in the presence of surface oxidants, for example, ferric or cupric ions, whereby the stannous salts can be directly oxidized to highly insoluble stannate salts. These stannate salts then precipitate onto the stainless steel surface to form a protective layer and provide the desired corrosion inhibition function. A third mechanism may be achieved under alkaline conditions whereby existing metal oxides are reduced to more stable reduced forms that incorporate insoluble stannate salts in a hybrid film.

In each of the above mechanisms, the final result is a stannate film, Tin (IV), formed on or at the stainless steel surface. The insolubility and stability of the resulting stannate film provides an effective barrier to corrosion for a limited time period even in the absence of additional stannous species being provided in the aqueous component of the treated system.

[Corrosion Inhibitor with Promoter]

In a first embodiment, there is provided a method of suppressing corrosion of a corrodible stainless steel surface that contacts a water stream in a water system. The method includes introducing into the water stream a treatment composition over a first time period, the treatment composition including a Tin(II) corrosion inhibitor and a hydroxycarboxylic acid promoter. The combination of the Tin(II) corrosion inhibitor and the hydroxycarboxylic acid promoter in a combined treatment feeding results in a synergistic anti-corrosive effect. For example, the combined treatment according to embodiments results in unexpectedly high anti-corrosion rates using relatively smaller effective amounts of Tin(II) and hydroxycarboxylic acid promoter that are otherwise not as effective in single treatment regimes. Without intending to be bound by theory, it is believed that the promoter compound is accomplishing two processes: (1) it is forming a corrosion inhibiting film on the stainless steel surface, and (2) it is effectively chelating the Tin(II) active state for a longer period of time than conventionally known thereby enabling the Tin(II) to react with the stainless steel surface and form a resilient Tin(IV) film. Although the mechanism is unknown, it is believed that the hydroxycarboxylic acid promotes the Tin(II) active state by acting as chelating agent.

In this embodiment, the corrosion inhibitor is preferably Tin(II). The corrosion inhibitor may be provided as a stannous salt selected from the group consisting of stannous sulfate, stannous bromide, stannous chloride, stannous oxide, stannous phosphate, stannous pyrophosphate, and stannous tetrafluroborate. Other reactive metal salts, for example, zirconium and/or titanium metal salts, may also be used in treatment methods according to the present disclosure. Indeed, embodiments of the disclosed methods should be operable with any metal salt capable of forming stable metal oxides resistant to dissolution under the conditions in the targeted system.

Promoter compounds particularly suitable for use in this embodiment are hydroxycarboxylic acids. Hydroxycarboxylic acids are carboxylic acids substituted with a hydroxyl group on adjacent carbon moieties. Hydroxycarboxylic acids are well known organic compounds applied in various applications. Examples include, but are not limited to, tartaric acid, glucaric acid, maleic acid, gluconic acid and polyaspartic acid. In embodiments, the promoter can be glucaric acid. In embodiments, the promoter can be a polymeric hydroxycarboxylic acid.

In this embodiment, a ratio of a concentration of the corrosion inhibitor in the water stream in terms of ppm to a concentration of the promoter in the water stream in terms of ppm is in the range of 0.001 to 0.4, 0.01 to 0.2666, or more preferably 0.05 to 0.1666. The ratio may also be in the range of 0.00025 to 0.4, 0.00033 to 0.2666, or more preferably 0.005 to 0.1666. In absolute terms, the first concentration of the Tin(II) corrosion inhibitor in the water stream may be present in relatively small amounts, e.g., in the range of 0.01 ppm to 3 ppm, 0.05 ppm to 2 ppm, or preferably, 0.1 ppm to 1.25 ppm, or more preferably, 0.3 ppm to 1.25 ppm, in the water system. The first concentration of the hydroxycarboxylic acid promoter in the water stream may be present in the range of 0.1 ppm to 40 ppm, 0.5 ppm to 30 ppm, or preferably, 5 ppm to 20 ppm, or more preferably, 7.5 ppm to 20 ppm, in the water system. The concentration of the inhibitor and promoter achieved during the corrosion inhibitor treatment can be selected to exceed the baseline system demand and thereby ensure that a portion of the inhibitor fed is available to treat the vulnerable metal surfaces.

The concentration of the combined corrosion inhibitor and hydroxycarboxylic acid promoter (i.e., the RPSI) in the water stream may be in the range of 0.1 to 1000 ppm. Preferably, the concentration of the RPSI is in the range of 1 to 100 ppm, 3 to 50 ppm, 6 to 50 ppm, or more preferably 12 to 25 ppm or 18 to 25 ppm.

The chemical make-up of the water stream in which the RPSI treatment is effective is not particularly limited. In this regard, the RPSI treatment is effective in any suitable water environment. As discussed herein, stainless steels are subject to pitting and crevice corrosion in warm chloride environments and to stress corrosion cracking above about 140° F. metal skin temperature. To that end, the disclosed methods are particularly advantageous in high skin temperature environments including in a range of 100 ppm to 5,000 ppm environments. Preferably, the chemistry of the target water stream may include 100 ppm to 2,000 ppm, 200 ppm to 2,000 ppm, 500 ppm to 1,500 ppm, and more preferably 750 ppm to 1,000 ppm chloride. For purposes of this disclosure, high skin temperature may mean 100° F. to 200° F., 120° F. to 180° F., 130° F. to 170° F., 130° F. to 150° F., or more preferably 140° F. to 180° F.

The method and manner by which a corrosion treatment is infused into a water stream is not particularly limited by this disclosure. Treatment can be infused into the water system at a cooling tower, for example, or any suitable location of the water stream in the water system. Methods for infusing the corrosion treatment, including controlling the flow of the infusion, may include a multi-valve system or the like, as would be understood by one of ordinary skill in the art. Moreover control of the treatment while in the system is not particularly limited. Infusion control, including frequency, duration, concentrations, dosing amounts, dosing types and the like, may be controlled manually or automatically through, for example, an algorithm or a computer executable medium, such as a CPU. These controls may further be implemented with data and history-driven machine-learning capabilities and feedback loops for automatically adapting treatment regimens to system and metallic surface environmental conditions. The treatment can be continuous, intermittent or periodic. The Tin(II) corrosion inhibitor can be added to the water stream apart from the hydroxycarboxylic acid promoter, or each can be added separately.

The treatment may stay in the system for a full cycle (i.e., through a heat exchanger, etc.) or several cycles, and is then gradually removed from the system with the process water in the system, for example, through known blowdown removal techniques in the case of a cooling water. Corrosion inhibitors are consumed within a treated system in various ways. These consumption pathways can be categorized as system demand and surface demand. Together, system demand and surface demand comprise total inhibitor demand.

The amount of the treatment composition can be applied based on the system demand and surface demand for the inhibitor. Controlling the amount of the treatment composition can utilize a number of parameters associated with surface and system demands including, for example, the concentration of corrosion products in the water or the demand of a surface of the stainless steel for reduction species. Other parameters such as on-line corrosion rates and/or oxidation reduction potential (ORP) may also be used for controlling the treatment frequency or monitoring system performance.

The treatment may include, in addition to the corrosion inhibitor or a salt thereof, such as Tin(II)/stannous chloride or the like, many other materials. For example, the treatment may comprise, at least one of citric acid, benzotriazole and 2-Butenedioic acid (Z), bicarbonates for increasing the alkalinity of the solution, a polymeric dispersant, such as 2-acrylamido-2-methylpropane sulfonic acid (AMPS), for inhibiting silt or fouling, and polymaleic acid (PMA) for inhibiting scaling. The treatment may include, for example, ChemTreat FlexPro™ CL5632 (a phosphorous-free and zinc-free corrosion treatment), manufactured by ChemTreat, Inc., or the like.

The corrosion inhibitor composition may be shot-dosed, service-dosed or continuously fed. The duration of the treatment dosing can range from 5 minutes to 2 days, or more preferably, from 10 minutes to 24 hours, in the case of shot-dosing. The duration of service-dosing may be substantially the same or less depending on the target concentration requirements in the water stream. Similarly, the duration of continuous feeding treatments depend on system demand as discussed herein.

At the early stages of the treatment in a system with existing corrosion and/or exposed stainless steel surfaces, the total inhibitor demand will be high but will decrease as stainless steel surfaces are treated by the inhibitor treatment. A treatment end point is reached where all surfaces are treated and only the system (non-metal surface) demand remains. Once effective treatment is achieved using the treatment period(s), the system can be operated for extended periods without the need for any further addition of corrosion inhibitor or with a substantially reduced level of corrosion inhibitor.

In another embodiment, after the period where substantially reduced levels of corrosion inhibitor are added, the method may include introducing into the water stream the treatment composition over a second time period, during which a second concentration of the corrosion inhibitor in the water stream may be substantially the same or less than the initial concentration of the corrosion inhibitor. In the second time period, a second concentration of the promoter in the water stream may be substantially the same or less than the first concentration of the promoter. The duration of the second time period is not particularly limited and may be shorter of longer than the first time period depending on system requirements.

In embodiments employing such intermittent or periodic treatment, the frequency or time between treatments is not particularly limited. The frequency may be from about 2 to 30 days, or preferably 3 to 7 days. More preferably, the time between treatments is about 7 days. In some systems, it may be beneficial to maintain some continuous level of active corrosion inhibitor in the water process stream after the treatment period. Maintaining a continuous low to very low level of active corrosion inhibitor after the treatment dosing may reduce the frequency at which subsequent treatments are needed. The duration, timing and concentration of the treatment doses can vary with the system demand as described herein.

As will be appreciated, the frequency of the combination feedings and the inhibitor and promoter concentrations necessarily will be a function of the system being treated and can be set and/or adjusted empirically based on test or historical data. In embodiments, the concentration of the inhibitor achieved during the treatment can be selected to exceed the baseline system demand and thereby ensure that a portion of the inhibitor fed is available to treat the vulnerable stainless steel surfaces.

The success of the treatment may be evaluated by monitoring the total inhibitor demand which, when the surface demand is effectively suppressed or eliminated, will be essentially equal to the system demand. The system demand, in turn, can be measured indirectly by monitoring parameters such as ORP and oxygenation levels. Thus, according to one embodiment, the treatment method may further comprise measuring and monitoring a characteristic of the metal surface or water stream during or after treatments to determine a time to initiate the treatment comprising the corrosion inhibitor and promoter, and/or a concentration of the inhibitor and promoter in the treatment composition.

If desired, additional corrosion inhibition and/or water treatment chemistry known in the art can be introduced into the system in conjunction with the combination feeding to further improve corrosion performance and control deposition of undesirable species. As will be appreciated, the treatment methods according to the disclosure can be paired with other treatment or conditioning chemistries that would be compromised by the continuous presence of the corrosion inhibitor. Alternatively, “greener” treatment packages or treatment packages designed to address other parameters of the system operation can be utilized between the intermittent feedings to improve the quality of the system effluent and/or reduce the need for effluent treatment prior to discharge.

According to one embodiment, treatment composition may comprise a reducing agent. Controlling the amount of reducing agent, including frequency, duration and concentration, according to methods described herein, may lead to more effective corrosion inhibition methods. The reducing agent may be, for example, erythrobate, glycolic acid or other aliphatic polycarboxylic acid, amine carboxylic acid, phosphonocarboxylic acid, hydroxycarboxylic acids, hydroxyphosphono carboxylic acid based complexing agents, or combinations thereof.

The treatment composition can include adding stannous in conjunction with one of more secondary corrosion inhibitor including, for example, inorganic and organic phosphates, zinc salts, nitrite/nitrate salts, molybdate salts, chromate salts, unsaturated carboxylic acid polymers such as polyacrylic acid, homo or co-polymaleic acid (synthesized from solvent and aqueous routes); acrylate/2-acrylamido-2-methylpropane sulfonic acid (AMPS) copolymers, acrylate/acrylamide copolymers, acrylate homopolymers, terpolymers of carboxylate/sulfonate/maleate, terpolymers of acrylic acid/AMPS; phosphonates and phosphinates such as 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinic oligomer (PSO); salts of molybdenum and tungsten including, for example, nitrates and nitrites; amines such as N,N-diethylhydroxylamine (DEHA), diethyl amino ethanol (DEAE), dimethylethanolamine (DMAE), cyclohexylamine, morpholine, monoethanolamine (MEA); azoles such as tolyltriazole (TTA), benzotriazole (BZT), butylbenzotriazole (BBT), halogenated azoles and their salts.

The treatment composition may further comprise at least one chelating agent such as, for example, citric acid, azole based copper corrosion inhibitors such as benzotriazole and 2-Butenedioic acid (Z), halogenated azoles and their derivatives. The treatment composition may further comprise scale inhibitors and dispersants selected from the group consisting one or more of unsaturated carboxylic acid polymers such as polyacrylic acid, homo or co-polymaleic acid (synthesized from solvent and aqueous routes); acrylate/2-acrylamido-2-methylpropane sulfonic acid (APMS) copolymers, acrylate/acrylamide copolymers, acrylate homopolymers, terpolymers of carboxylate/sulfonate/maleate, terpolymers of acrylic acid/AMPS; phosphonates and phosphinates including 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinic oligomer (PSO); salts of molybdenum and tungsten including nitrates and nitrites; amines such as N,N-diethylhydroxylamine (DEHA), diethyl amino ethanol (DEAE), dimethylethanolamine (DMAE), cyclohexylamine, morpholine, monoethanolamine (MEA), a biocide, and combinations thereof.

In another embodiment, there is provided a chemical treatment composition used to suppress corrosion of a corrodible stainless steel surface that contacts a water stream in a water system. The composition including the Tin(II) corrosion inhibitor and the hydroxycarboxylic acid promoter as described herein. The composition can be an aqueous composition that is fed into a water stream of the water system. The corrosion inhibitor may be present in an amount in the range of 0.01 to 10 wt %, 0.1 to 5 wt %, or 1 to 5 wt %. The promoter may be present in an amount in the range of 0.1 to 40 wt %, 1 to 25 wt %, or 10 to 25 wt %.

In embodiments, the treatment composition may be introduced into open or closed water systems. Further, the treatment can be applied to the water stream while the water system is on-line. Alternatively, the treatment composition may be introduced into the water stream while the system is offline such as during pre-treating the corrodible metal surface before the equipment is brought into service in the water system.

### EXAMPLES

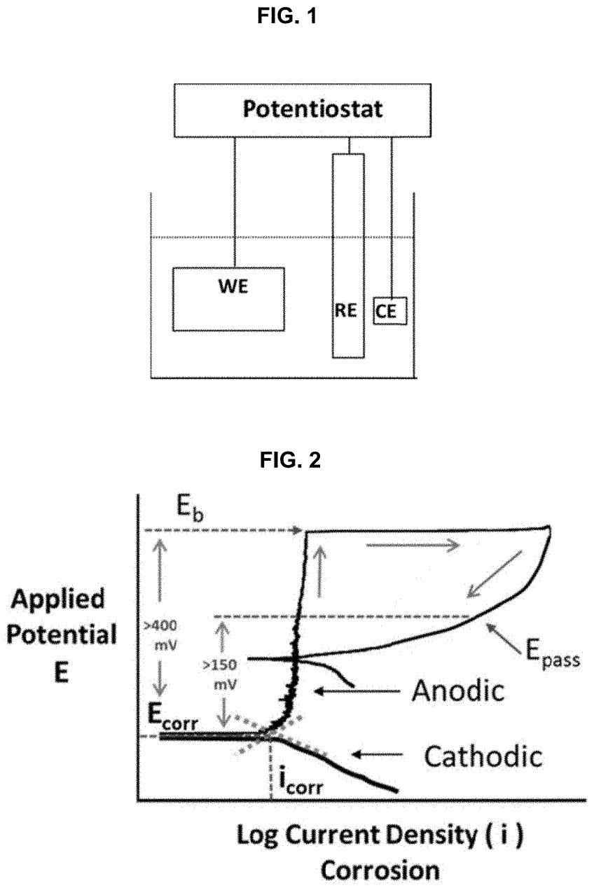

The following Examples illustrate applications of the treatment methods disclosed herein in the context of the electrochemical setup illustrated in FIG. 1, which includes a working electrode (WE), reference electrode (RE) and counter electrode (CE). Electrochemical techniques such as cyclic polarization have been extensively used in the laboratory to evaluate susceptibility to localized corrosion. Critical parameters such as corrosion potential, pitting potential, corrosion current and repassivation potentials can be determined from the cyclic polarization experiment.

The cyclic polarization curve illustrated in FIG. 2 shows corrosion potential (E_{corr}), breakdown potential (E_{b}), passivation potential (Eₚₐₛₛ) and corrosion current (I_{corr}). From the cyclic polarization curve illustrated in FIG. 2, important parameters such as pitting potential (Eₚᵢₜ) and repassivation potential (E_{RP}) can be calculated as follows in Formulas (1) and (2):

Eₚᵢₜ=E_{b}−E_{corr} (1)

E_{RP}=Eₚₐₛₛ−E_{corr} (2)

It is generally accepted that an Eₚᵢₜ value of >350 to 400 mV coupled with an E_{RP} of >150 mV indicates that there is minimal to no possibility of localized corrosion, and the alloy is suitable for long-term applicability in that environment.

### Example I

In each of Samples 1-4, Type 304 stainless steel (SS) coupons were tested in Richmond, Va. tap water containing 750 ppm chloride at a temperature of 150° F. Sample 1 (Blank) was a control sample and Samples 2, 3, 4 were treated with 6 ppm, 12 ppm and 18 ppm, respectively, of the disclosed RPSI treatment. The results are shown in Table 1.

TABLE 1
Various corrosion parameters calculated from Type 304
SS coupons tested in Richmond, VA tap water containing
750 ppm chloride at a temperature of 150° F.

| | | E_{corr} | Eₚᵢₜ | Eᵣₚ | I_{corr} |
|---|---|---|---|---|---|
| | Treatment | mV | mV | mV | μA/cm² |
| Sample 1 | Blank | 62 | 180 | −5 | 0.68 |
| Sample 2 | 6 ppm RPSI | 42 | 225 | 122 | 0.32 |
| Sample 3 | 12 ppm RPSI | 47 | 420 | 168 | 0.14 |
| Sample 4 | 18 ppm RPSI | 39 | 518 | 219 | 0.072 |

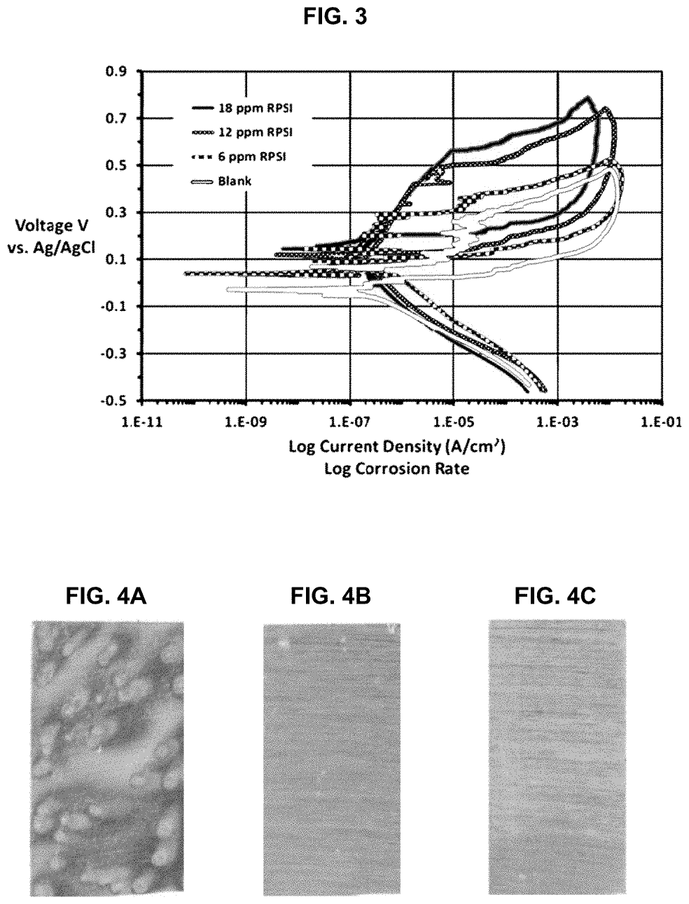

The various corrosion parameters in Table 1 are illustrated graphically in FIG. 3. It is evident from FIG. 3 and Table 1 that the pitting and repassivation potentials increase with increase in the dosage of RPSI. At 12 ppm dosage of RPSI, the Eₚᵢₜ and E_{RP} satisfy the requirement of Eₚᵢₜ>400 mV and E_{RP}>150 mV and confirm that Type 304 SS does not undergo localized corrosion under these conditions.

FIGS. 4A-4C show pictures of Sample 1 without the treatment program (FIG. 4A), Sample 3 with 12 ppm RPSI (FIG. 4B) and Sample 4 with RPSI 18 ppm (FIG. 4C). As seen from visual inspection of these pictures, localized corrosion clearly exists in Sample 1, whereas Samples 3 and 4 both exhibit superior surface quality.

### Example II

In each of Examples 5-8, Type 304 SS coupons were tested in Richmond, Va. tap water containing 1000 ppm chloride at a temperature of 150° F. Sample 5 (Blank) was a control sample, Samples 6 and 7 were Comparative Examples with 15 ppm Zn and 250 ppm Mo, respectively, and Sample 8 was treated with 25 ppm of the disclosed RPSI treatment. The results are shown in Table 2.

TABLE 2
Various corrosion parameters calculated from Type 304
SS coupons tested in Richmond, VA tap water containing
1000 ppm chloride at a temperature of 150° F.

| | | | E_{corr} | Eₚᵢₜ | Eᵣₚ | I_{corr} |
|---|---|---|---|---|---|---|
| | Treatment | | mV | mV | mV | μA/cm² |
| Sample 5 | Blank | | 97 | 107 | | |
| Sample 6 | 15 | ppm Zn | −27 | 128 | 52 | 1.42 |
| Sample 7 | 250 | ppm Mo | 55 | 300 | 120 | 0.68 |
| Sample 8 | 25 | ppm RPSI | 79 | 553 | 195 | 0.12 |

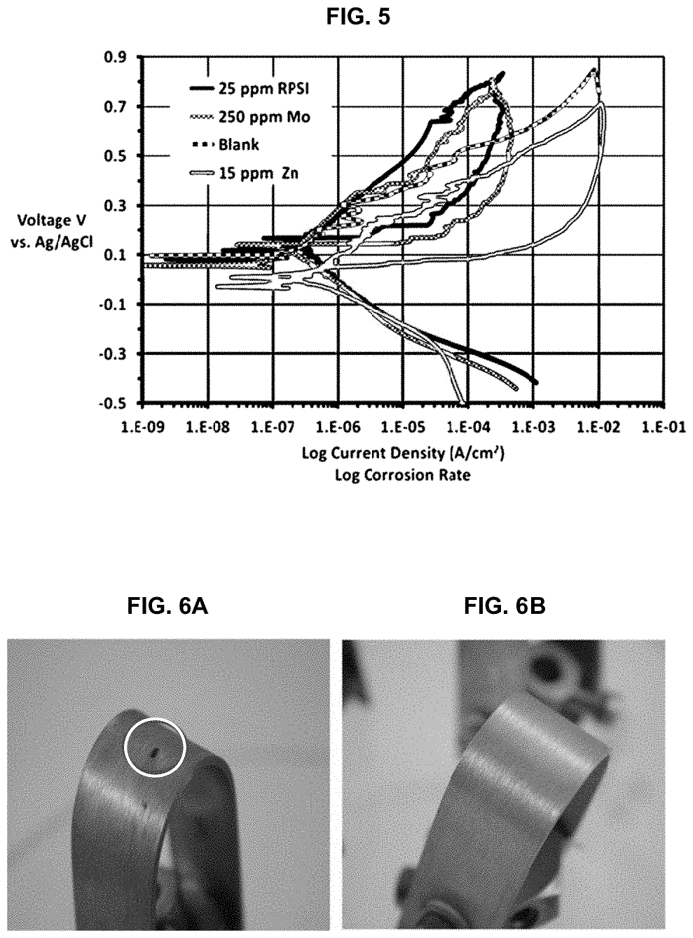

The various corrosion parameters in Table 2 are illustrated graphically in FIG. 5. It is clear from FIG. 5 and Table 2 that the RPSI treatment program in Sample 8 was superior to the blank (Sample 5) and the other treatment programs (Samples 6 and 7) in terms of higher pitting and repassivation potentials. The observed pitting potential for the RPSI treatment is 553 mV, which was well above the generally accepted criteria of 400 mV for pitting resistance. Similarly, the observed repassivation potential for RPSI of 195 mV was well above the accepted criteria of 150 mV for pitting resistance. This data clearly suggests that Type 304 SS will not undergo localized corrosion under the conditions of treatment with 25 ppm RPSI.

### Example III

Chlorides are the essential contributor to stress corrosion cracking of stainless steels. High chloride concentrations, resulting from elevated chloride levels in the makeup water, high cycles of concentration, and chlorination, will increase susceptibility to stress corrosion cracking. Stress corrosion cracking in stainless steels mainly occurs at temperatures above 130-140° F. Laboratory studies were always conducted at temperatures greater than 200° F. to accelerate the cracking process. The most likely areas for stress corrosion cracking to be initiated are crevices or areas where the flow of water is restricted. Hence, stopping crevice corrosion is critical to mitigating stress corrosion cracking in stainless steels.

High temperature autoclaves made of Hastelloy material were used to carrying out immersion studies with U-bent Type 304 SS specimens. These Type 304 SS coupons were immersed in Richmond, Va. tap water with 1000 ppm added chlorides at 220° F. under compressed air pressure. After 15 days of immersion, U-bent coupons were taken out of the autoclaves, photographed, and examined under microscope for possible localized corrosion and stress corrosion cracking.

FIGS. 6A and 6B show the U-bent Type 304 SS coupon Sample 9 with no treatment (FIG. 6A) and Sample 10 with 25 ppm of RPSI treatment (FIG. 6B). It is clear from FIGS. 6A and 6B that the untreated coupon of Sample 9 exhibited large pits over the entire surface area with slightly larger pits at the U-bent. In contrast, Sample 10 with 25 ppm RPSI looked clean, with no localized corrosion. General discoloration of the untreated coupon in Sample 9 (FIG. 6A) indicates that the alloy underwent general corrosion, whereas the coupon in Sample 10 with 25 ppm RPSI is shiny and clean.

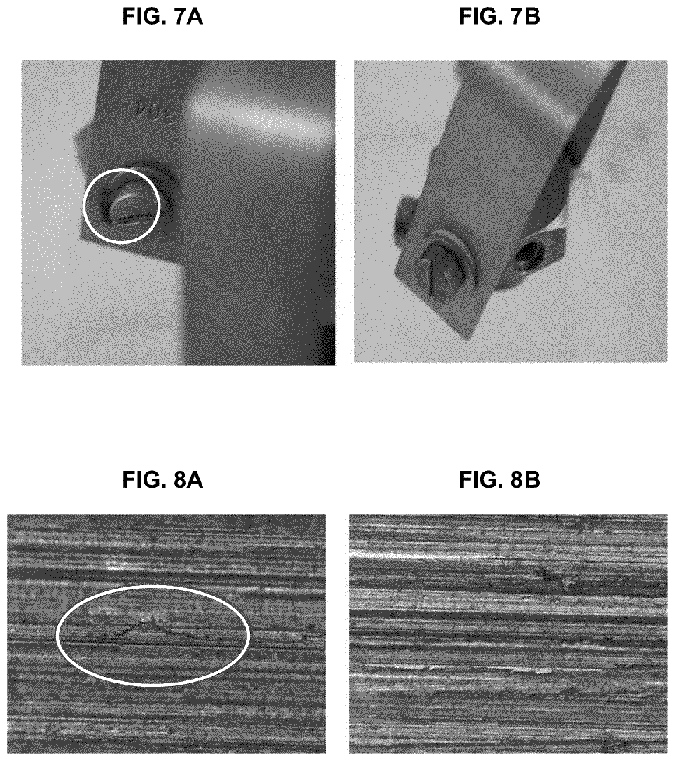

FIGS. 7A and 7B show the same U-bent Type 304 SS coupon Samples 9 and 10 at the crevice washers with no treatment (FIG. 7A) and with 25 ppm of RPSI treatment (FIG. 7B). As seen in FIGS. 7A and 7B, Sample 9 with no treatment underwent severe crevice corrosion under these conditions, whereas Sample 10 with 25 ppm of RPSI provides sufficient corrosion inhibition to mitigate the crevice attack. As mentioned above, crevice corrosion is one of the main reasons for stress corrosion cracking in stainless steels. This is due to the buildup of corrosion products and reduced or restricted water flow. This data clearly shows that there is high probability for untreated Type 304 SS to undergo stress corrosion cracking under these conditions, whereas 25 ppm RPSI provides localized corrosion inhibition sufficient to mitigate stress corrosion cracking.

FIGS. 8A and 8B show the same U-bent Type 304 SS coupon Samples 9 and 10 at areas around the U-bend observed under an optical microscope for possible stress corrosion cracking with no treatment (FIG. 8A) and with 25 ppm of RPSI treatment (FIG. 8B). As clearly seen in FIG. 8A, there is an initiation of stress crack at the U-bend in Sample 9 without treatment, whereas there were no cracks in Sample 10 with 25 ppm RPSI, as seen in FIG. 8B. From the visual evidence of crack development at the U-bend, as well as smaller cracks observed in the crevice washer area, this data shows that Type 304 SS undergoes stress corrosion cracking under these conditions in the absence of an effective corrosion inhibitor. It is also evident that the disclosed RPSI chemistry effectively inhibits localized corrosion and stress corrosion cracking on Type 304 SS.

In summary, the treatment methods using Tin corrosion inhibitor and hydroxycarboxylic acid promoter in combination (i.e., RPSI) resulted in dramatically better anti-corrosion characteristics in stainless steels while allowing for substantially less Tin than is required in conventional methods using other corrosion inhibitors.

It will be appreciated that the above-disclosed features and functions, or alternatives thereof, may be desirably combined into different systems or methods. Also, various alternatives, modifications, variations or improvements may be subsequently made by those skilled in the art, and are also intended to be encompassed by the following claims. As such, various changes may be made without departing from the spirit and scope of this disclosure as defined in the claims.

What is claimed is:

1. A method of suppressing corrosion of a corrodible stainless steel surface that contacts a water stream in a water system, the method comprising:
introducing into the water stream that contacts the corrodible stainless steel surface a treatment composition including a Tin(II) corrosion inhibitor and a hydroxycarboxylic acid promoter,
wherein the treatment composition is introduced so that a concentration of the treatment composition in the water stream is in the range of 0.1 ppm to 1000 ppm.

2. The method of suppressing corrosion according to claim 1, wherein the concentration of the treatment composition in the water stream is in the range of 6 ppm to 50 ppm.

3. The method of suppressing corrosion according to claim 1, wherein the concentration of the treatment composition in the water stream is in the range of 12 ppm to 25 ppm.

4. The method of suppressing corrosion according to claim 1, wherein the concentration of the treatment composition in the water stream is in the range of 18 ppm to 25 ppm.

5. The method of suppressing corrosion according to claim 1, wherein the treatment composition is introduced so that a concentration of tin in the water stream is in the range of 0.01 ppm to 3 ppm.

6. The method of suppressing corrosion according to claim 5, wherein the first concentration of the tin in the water stream is in the range of 0.05 ppm to 2 ppm.

7. The method of suppressing corrosion according to claim 5, wherein the first concentration of the tin in the water stream is in the range of 0.1 to 1.25 ppm.

8. The method of suppressing corrosion according to claim 1, wherein the treatment composition is introduced so that a concentration of the promoter in the water stream is in the range of 0.1 ppm to 40 ppm.

9. The method of suppressing corrosion according to claim 8, wherein the concentration of the promoter in the water stream is in the range of 0.5 ppm to 30 ppm.

10. The method of suppressing corrosion according to claim 8, wherein the concentration of the promoter in the water stream is in the range of 7.5 to 20 ppm.

11. The method of suppressing corrosion according to claim 1, wherein the hydroxycarboxylic acid is selected from the group consisting of tartaric acid, glucaric acid, maleic acid, gluconic acid, and polyaspartic acid.

12. The method of suppressing corrosion according to claim 1, wherein the corrosion inhibitor is provided as a stannous salt selected from the group consisting of stannous sulfate, stannous bromide, stannous chloride, stannous oxide, stannous phosphate, stannous pyrophosphate, and stannous tetrafluroborate.

13. The method of suppressing corrosion according to claim 1, wherein the treatment composition further comprises at least one reducing agent selected from the group consisting of erythrobate, glycolic acid or other aliphatic polycarboxylic acid, amine carboxylic acid, phosphonocarboxylic acid, hydroxycarboxylic acids, and hydroxyphosphono carboxylic acid based complexing agents.

14. The method of suppressing corrosion according to claim 1, wherein the water system is selected from the group consisting of cooling towers, water distribution systems, boilers, water/brine carrying pipelines, and storage tanks.

15. The method of suppressing corrosion according to claim 1, wherein the treatment composition is provided in sufficient amount and for sufficient time to form a stable protective tin film on at least a portion of the corrodible stainless steel surface

16. The method of suppressing corrosion according to claim 1, wherein the treatment composition is introduced into the water stream while the water system is on-line.

17. The method of suppressing corrosion according to claim 1, wherein the treatment composition is introduced into the water stream so that the initial ratio of a concentration of the corrosion inhibitor in the water stream in terms of ppm to a concentration of the promoter in the water stream in terms of ppm is in the range of 0.001 to 0.4.

18. The method of suppressing corrosion according to claim 1, wherein the water stream includes chloride in a range of 100 ppm to 2,000 ppm, and
a skin temperature of the stainless steel surface is in a range of 100° F. to 200° F.

19. The method of suppressing corrosion according to claim 18, wherein the water stream includes chloride in a range of 750 ppm to 1,000 ppm, and
a skin temperature of the stainless steel surface is in a range of 130° F. to 150° F.

20. The method of suppressing corrosion according to claim 1, wherein the stainless steel is Type 304 stainless steel.
